(19) United States
(12) Patent Application Publication
(10) Pub. No.: US 2012/0321117 A1
(43) Pub. Date: Dec. 20, 2012

(54) PORTABLE ELECTRONIC DEVICE HAVING SOUND EMISSION HOLES ALIGNED WITH SPEAKER AT RECESS OF REAR COVER

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/598,645

(22) Filed: Aug. 30, 2012

Related U.S. Application Data
(63) Continuation-in-part of application No. 12/973,802, filed on Dec. 20, 2010.

(30) Foreign Application Priority Data
Oct. 21, 2010 (CN) 201010514505.1

(51) Int. Cl. H04R 1/02

(52) U.S. Cl. 381/333

(57) ABSTRACT

An exemplary portable electronic device includes a front cover having a display panel mounted thereon, a rear cover connected to the front cover, and two speakers received between the front cover and the rear cover. The rear cover defines two recesses in two side portions thereof. Each side portion of the rear cover defines sound emission holes communicating with the recess. Each speaker is located adjacent to and faces corresponding sound emission holes. Sound produced by each speaker transmits through the corresponding sound emission holes along a vertical direction perpendicular to the display panel, and spreads to the outside environment through an adjacent recess.

### CROSS-REFERENCE TO RELATED APPLICATION

The present application is a continuation-in-part (CIP) application of patent application Ser. No. 12/973,802, entitled “PORTABLE ELECTRONIC DEVICE HAVING OBLIQUE SOUND OUTPUT ARRANGEMENT,” and filed on Dec. 20, 2010. The disclosure of the parent application is incorporated herein by reference in its entirety.

BACKGROUND

1. Technical Field

The disclosure generally relates to portable electronic devices, and more particularly to a portable electronic device configured to provide optimum sound output for one or more speakers thereof.

2. Description of Related Art

A portable electronic device, such as a mobile phone, a tablet computer, a handheld game console, a personal digital assistant (PDA) or an MP4 (MPEG audio layer 4) player, usually has a built-in speaker, for users to listen to callers, listen to music, or play games for example. To obtain a high-quality sound effect, sound emission holes for the speaker are desired to be defined in a front side of the portable electronic device.

However, a display panel and some operating keys are usually arranged at the front side of the portable electronic device. The sound emission holes defined in the front side of the portable electronic device limit the area available for the display panel and the operating keys. To avoid this problem, sound emission holes of some portable electronic devices are instead defined in peripheral walls of the portable electronic device. A commonly used portable electronic device includes a shell, and two speakers arranged in the shell. The two speakers are located at two adjacent corners of the shell, respectively. Two sets of sound emission holes are defined in a peripheral wall of the portable electronic device, adjacent to two corners of the portable electronic device. Each set of sound emission holes is located adjacent to a corresponding speaker. However, the sound emission holes are disposed at a lateral side of the speaker, not a front (sound output) side of the speaker. Thus the intermediate frequency and high frequency ranges of the sound output from the portable electronic device are weakened, and users cannot fully appreciate or enjoy the sound when they listen to callers or music or play games. Further, the sound emission holes defined in the peripheral wall may be covered by a user's hands, thereby reducing the sound pressure.

What is needed, therefore, is a means to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the views.

FIG. 1 is an isometric, assembled view of a portable electronic device in accordance with a first embodiment of the present disclosure, showing the portable electronic device facing down.

FIG. 2 is an exploded view of the portable electronic device of FIG. 1, but showing the portable electronic device facing up, and omitting a plurality of components inside a shell of the portable electronic device.

FIG. 3 is a plan view of the portable electronic device of FIG. 1, showing a rear of the portable electronic device.

FIG. 4 is a side plan view of the portable electronic device of FIG. 1, but showing the portable electronic device facing up and resting on a horizontal surface.

FIG. 5 is an enlarged view of a circled portion V of FIG. 4.

FIG. 6 is similar to FIG. 4, showing a portable electronic device in accordance with a second embodiment of the present disclosure facing up and resting on a horizontal surface.

FIG. 7 is an enlarged view of a circled part VII of FIG. 6.

FIG. 8 is similar to FIG. 3, showing a rear of a portable electronic device in accordance with a third embodiment of the present disclosure.

### DETAILED DESCRIPTION

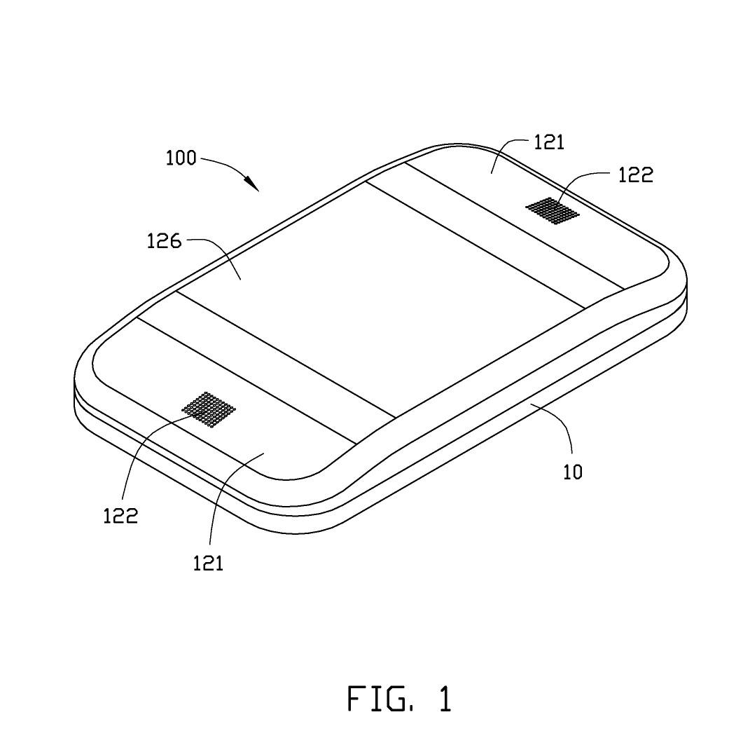

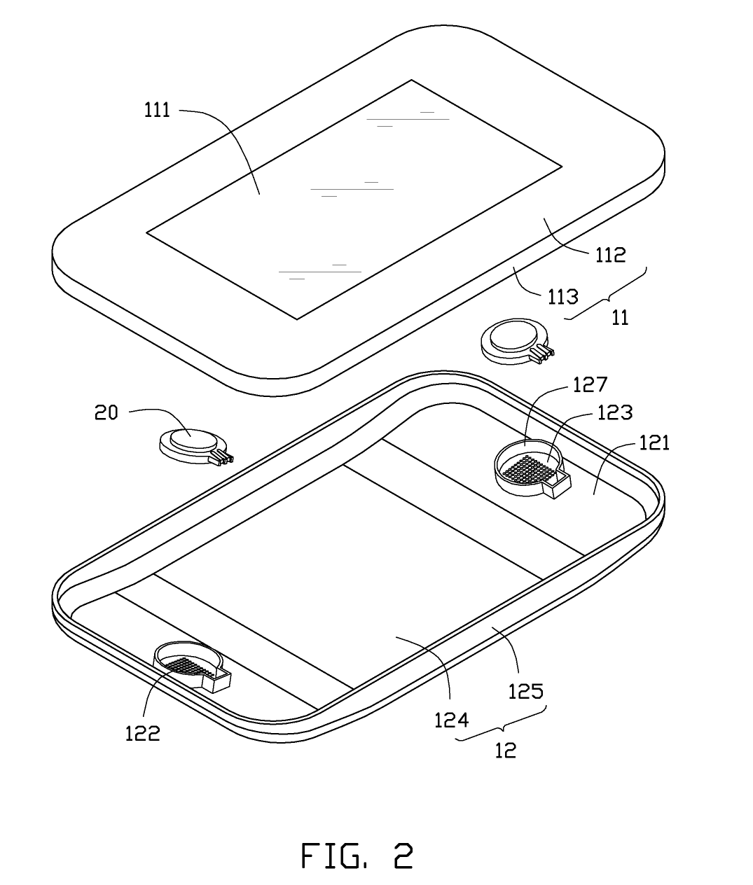

Referring to FIGS. 1-2, a portable electronic device 100 according to a first embodiment of the present disclosure is shown. The portable electronic device 100 can be a mobile phone, a tablet computer, a handheld game console, a PDA, an MP4 player, or another kind of handheld electronic device.

The portable electronic device 100 includes a generally flat shell 10 in which components of the portable electronic device 100, such as a circuit board, a central processing unit, a battery, a multimedia module and two speakers 20, are received. The shell 10 includes a front cover 11, and a rear cover 12 connected to the front cover 11. The front cover 11 and the rear cover 12 cooperatively define a receiving space therebetween for receiving the components of the portable electronic device 100.

The front cover 11 includes a substantially rectangular front plate 112, and a sidewall 113 extending from a peripheral edge of the front plate 112 towards the rear cover 12. The portable electronic device 100 has a display panel 111 fixed to a rear side of the front plate 112 and exposed from a window (not labeled) defined in a central area of the front plate 112. The display panel 111 has a substantially uniform thickness, and a front face of the display panel 111 is substantially coplanar with a front face of the front plate 112.

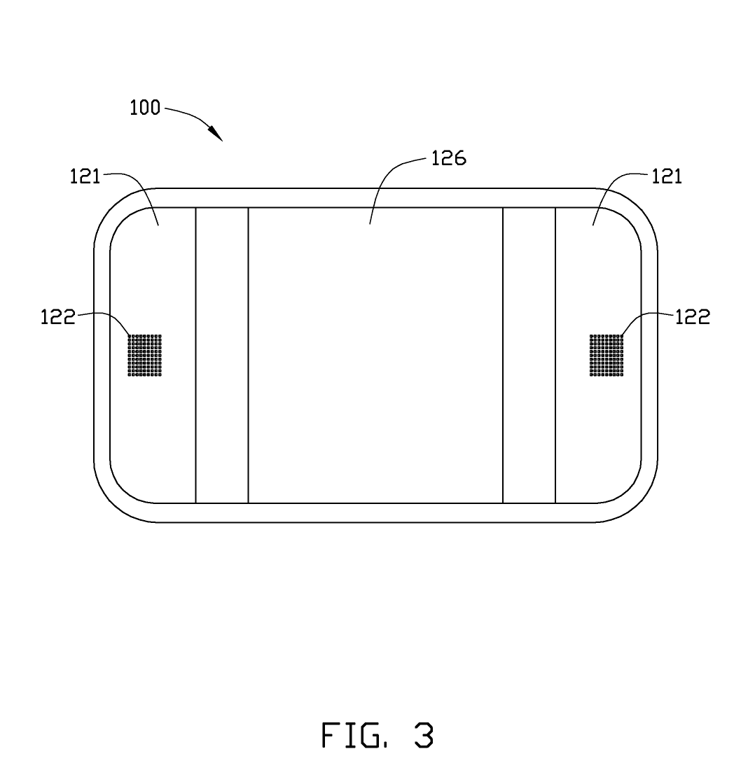

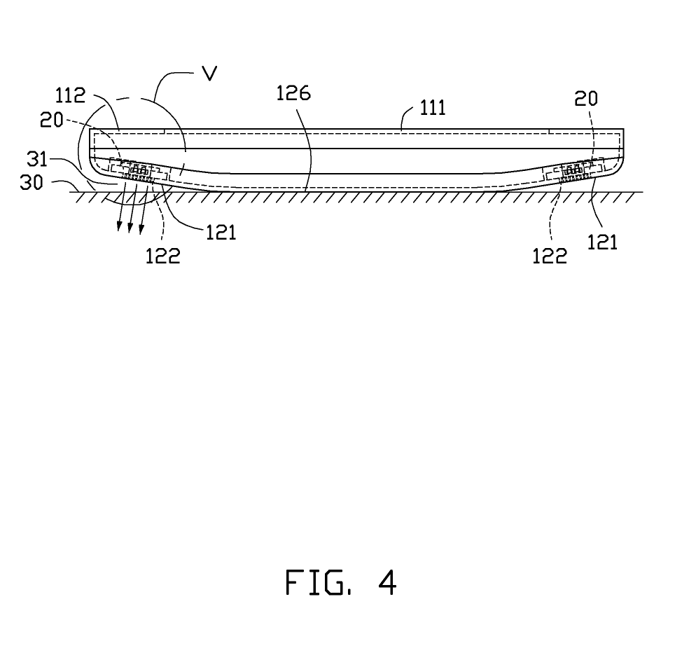

Referring also to FIG. 3, the rear cover 12 includes a substantially rectangular rear plate 124, and a sidewall 125 extending from a peripheral edge of the rear plate 124 towards the front cover 11. The rear plate 124 has a central flat portion 126 substantially parallel to the display panel 111, and two angled portions 121 at two opposite sides of the flat portion 126. The two angled portions 121 extend frontward and outwardly from two opposite sides of the flat portion 126 (see FIG. 4), respectively. Each angled portion 121 is located between the flat portion 126 and a corresponding short side of the sidewall 125 of the rear cover 12. The angled portion 121 defines a set of sound emission holes 122 therein. Each angled portion 121 may have a planar or curved outer surface. In the present embodiment, each angled portion 121 has a planar outer surface. A set of sound emission holes 122 is located in approximately a center of each angled portion 121, halfway along a longitudinal axis of the angled portion 121. In this embodiment, the longitudinal axis of the angled portion 121 is parallel to the corresponding short side of the sidewall 125 of the portable electronic device 100. The sound emission holes 122 of the angled portion 121 are arranged in a rectangular array (or matrix). Alternatively, the sound emission holes 122 of the angled portion 121 may be arranged in a circular array.

Referring to FIG. 4, when the shell 10 is disposed on a horizontal surface 30 with the display panel 111 facing up, a wedge-shaped gap 31 is defined between each angled portion 121 and the horizontal surface 30. Sound from the two sets of sound emission holes 122 can travel through the wedge-shaped gaps 31 to the ambient environment, whereby the sound volume and quality provided by the portable electronic device 100 is enhanced.

Each angled portion 121 of the rear plate 124 of the rear cover 12 forms a substantially annular wall 127 on an internal surface thereof, corresponding to and substantially surrounding the respective set of sound emission holes 122. The angled portion 121 and the annular wall 127 cooperatively define a sound chamber 123 therebetween for receiving a corresponding speaker 20. The sound chamber 123 is substantially cylindrical (or disk-shaped). Each set of sound emission holes 122 is defined in a region of the angled portion 121, which region can be considered to be surrounded by the annular wall 127. A ratio of an area of the set of sound emission holes 122 to an area of the region surrounded by the annular wall 127 is not less than 20%.

The two speakers 20 are arranged in the shell 10, and are located corresponding to the sets of sound emission holes 122 of the two angled portions 121. In particular, each speaker 20 is received in a corresponding sound chamber 123, with a sound output side of the speaker 20 (i.e., a side of the speaker 20 at which the diaphragm of the speaker 20 is located) facing the corresponding set of sound emission holes 122 of the shell 10.

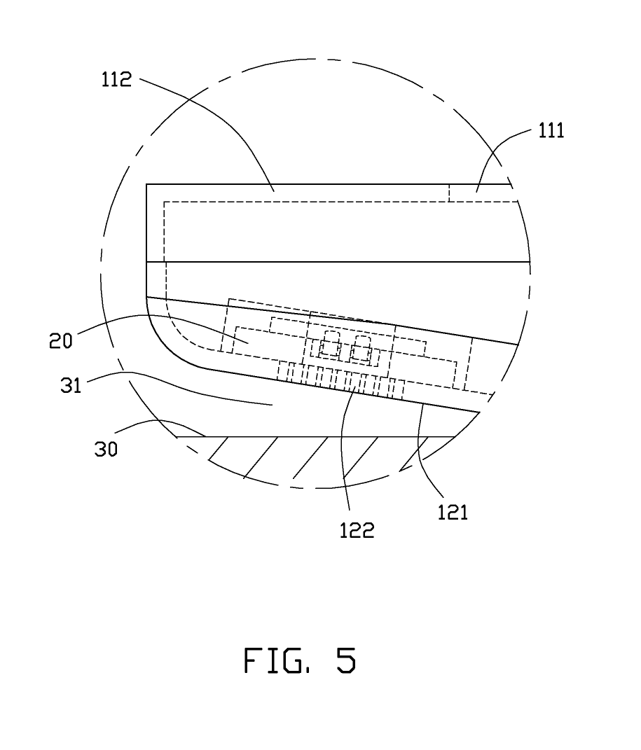

Referring also to FIG. 5, when each speaker 20 is in operation, sound emitted by the speaker 20 travels along the corresponding set of sound emission holes 122, through the corresponding wedge-shaped gap 31, and then to the ambient environment. An angle formed between a direction of maximum sound intensity of the speaker (indicated by the arrows in FIG. 4, i.e., an axial direction of each sound emission hole) and the front face of the display panel 111 is an acute angle. In other words, the direction of maximum sound intensity is neither parallel nor perpendicular to a plane of the display panel 111. Preferably, the angle between the direction of maximum sound intensity and the plane of the display panel 111 is selected to be in the range of from 30° to 60°.

The shell 10 has a symmetrical structure. The two angled portions 121 of the rear plate 124 are symmetrically arranged at the rear side of the shell 10. Alternatively, the rear plate 124 can provide four angled portions 121 at the rear side of the shell 10, with all four angled portions 121 adjacent to the sidewall 125 of the rear cover 12. Each angled portion 121 defines a set of sound emission holes 122 therein. Accordingly, four speakers 20 are provided in the shell 10, with each speaker 20 located corresponding to a respective set of sound emission holes 122.

In the portable electronic device 100, each set of sound emission holes 122 is defined in a corresponding angled portion 121 of the rear plate 124 of the shell 10. Thereby, the sound output side of the corresponding speaker 20 can be arranged directly adjacent to the sound emission holes 122. Compared with a conventional portable electronic device in which sound emission holes are disposed at a lateral side of a speaker, the portable electronic device 100 has significantly strengthened intermediate frequency and high frequency ranges (particularly 5 kHz to 20 kHz) of output sound. Therefore, the portable electronic device 100 permits its users to fully appreciate and enjoy the sound when they listen to a caller or music or play games. Further, the portable electronic device 100 helps to prevent the sound emission holes 122 from being covered by a user's hands, while still allowing convenient placement and arrangement of the display panel 111 and operating keys thereof. That is, the portable electronic device 100 avoids inadvertent and unwanted reduction of sound pressure.

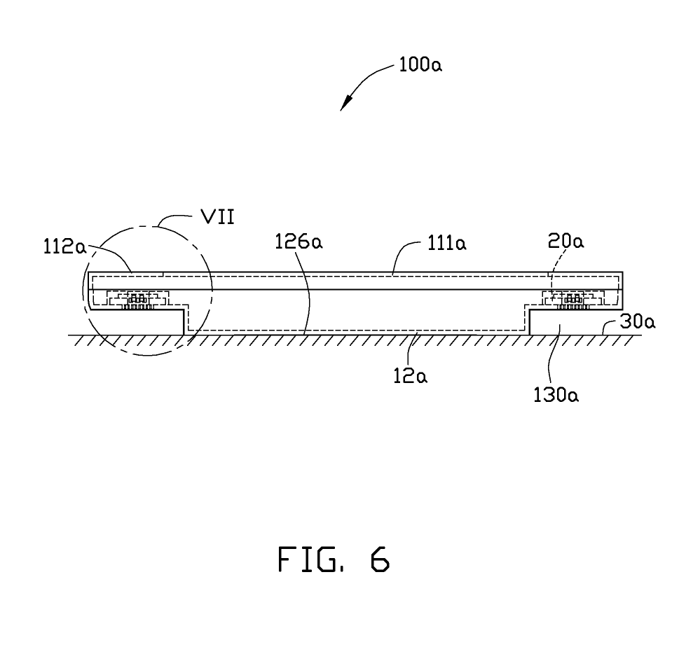

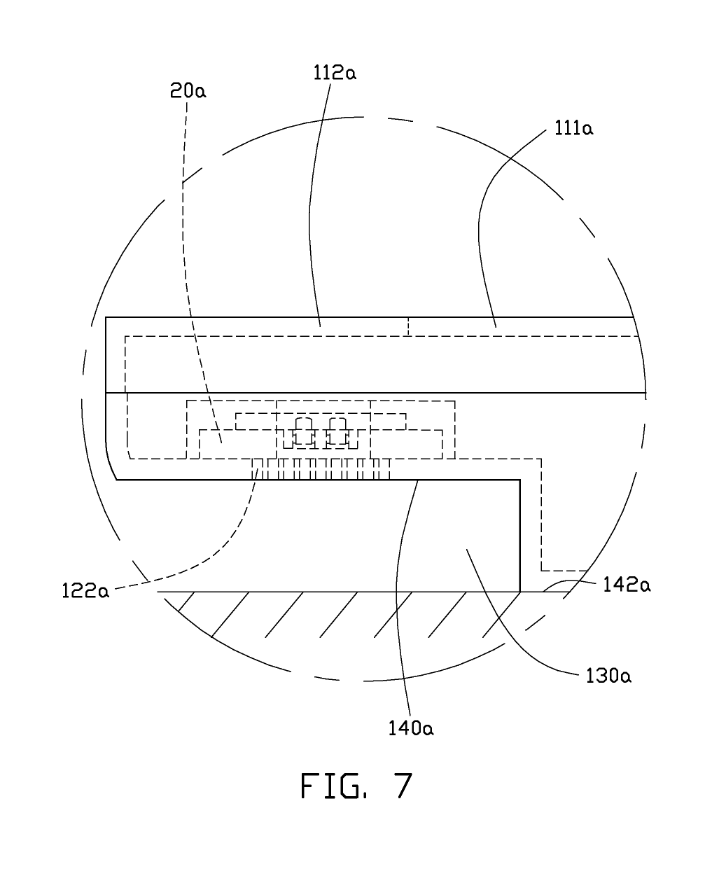

Referring to FIGS. 6-7, a portable electronic device 100a in accordance with a second embodiment of the present disclosure is shown. Different from the portable electronic device 100 of the first embodiment, the portable electronic device 100a has two external recesses 130a defined in two side portions of a rear cover 12a thereof, respectively. Each recess 130a has an inner face 140a, which is parallel to a rear face 142a of a flat portion 126a of the rear cover 12a, and is also parallel to a display panel 111a of the portable electronic device 100a. The rear face 142a of the rear cover 12a is disposed on a horizontal surface 30a, with the inner face 140a of each recess 130a being spaced from the horizontal surface 30a.

A set of sound emission holes 122a is defined in the inner face 140a of each recess 130a, i.e., in the corresponding side portion of the rear cover 12a. Each of the sound emission holes 122a extends along a vertical direction, perpendicular to the inner face 140a of the recess 130a. A speaker 20a is disposed adjacent to inner ends of the sound emission holes 122a. A substantially annular wall is formed on a front face of the end portion of the rear cover 12a at the sound emission holes 122a, and surrounds the speaker 20a. In FIGS. 6-7, only outlines of the substantially annular wall are shown, with broken lines. The speaker 20a has a sound output side facing the sound emission holes 122a, so that the sound generated from the speaker 20a can spread along vertical directions to the corresponding recess 130a through the sound emission holes 122a. The sound in the recess 130a is reflected by the horizontal surface 30a, and by a lateral face of the recess 130a which interconnects the inner face 140a of the recess 130a and the rear face 142a of the rear cover 12a, and propagates to the ambient environment. A direction of a maximum sound intensity of the speaker 20a is parallel to the vertical direction.

The other elements (such as a front plate 112a of a front cover) of the portable electronic device 100a not mentioned above are substantially the same as those of the portable electronic device 100 of the first embodiment.

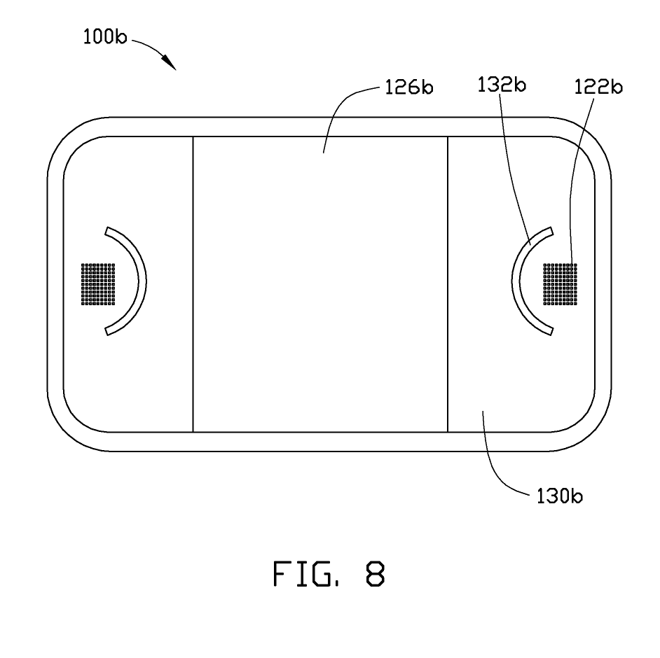

FIG. 8 shows a portable electronic device 100b in accordance with a third embodiment of the present disclosure. Different from the portable electronic device 100a of the second embodiment, the portable electronic device 100b has two reflection plates 132b formed in two recesses 130b, respectively, to facilitate reflection of sound to the ambient environment. The two reflection plates 132b are located at two opposite sides of a flat portion 126b, with each reflection plate 132b adjacent to a corresponding set of sound emission holes 122b. Each reflection plate 132b extends rearward from an inner face (not labeled) of the corresponding recess 130b, in a direction generally away from the sound emission holes 122b. The reflection plate 130b is curved, and partially surrounds the set of sound emission holes 122b, with a concave side of the reflection plate 130b facing the set of sound emission holes 122b.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A portable electronic device comprising:
a shell comprising a front cover at a front side thereof, and a rear cover at a rear side thereof, an external recess being defined in a side portion of the rear cover, and a plurality of sound emission holes being defined in the side portion of the rear cover at the recess;
a display panel arranged at the front side of the shell; and
a speaker received in the shell and located corresponding to the sound emission holes, the speaker producing sound in a direction substantially perpendicular to a plane of the display panel, the sound transmitting through the sound emission holes and the recess to an outside environment.

2. The portable electronic device of claim 1, wherein each of the sound emission holes extends along the direction substantially perpendicular to the plane of the display panel.

3. The portable electronic device of claim 1, wherein the recess has an inner face substantially parallel to the plane of the display panel, the sound emission holes extending through the inner face of the recess.

4. The portable electronic device of claim 1, wherein the sound emission holes are arranged in a matrix.

5. The portable electronic device of claim 1, wherein the speaker has a sound output side located adjacent to and facing the sound emission holes.

6. The portable electronic device of claim 3, wherein the rear cover comprises a rear face adjacent to the inner face of the recess, the rear face being substantially parallel to the inner face of the recess.

7. The portable electronic device of claim 6, wherein the inner face of the recess is located nearer the display panel than the rear face of the rear cover.

8. The portable electronic device of claim 1, wherein the rear cover comprises an internal substantially annular wall surrounding the sound emission holes, the speaker being enclosed by the substantially annular wall.

9. The portable electronic device of claim 3, wherein the rear cover comprises a reflection plate adjacent to the sound emission holes.

10. The portable electronic device of claim 9, wherein the reflection plate is formed on the inner face of the recess.

11. The portable electronic device of claim 9, wherein the reflection plate is curved and partially surrounds the sound emission holes.

12. The portable electronic device of claim 1, wherein a direction of a maximum intensity of the sound produced from the speaker is parallel to the direction substantially perpendicular to the plane of the display panel.

13. A portable electronic device comprising:
a front cover having a display panel mounted thereon;
a rear cover connected to the front cover, the rear cover defining an external recess in a side portion thereof, and the side portion of the rear cover defining a plurality of sound emission holes in communication with the recess; and
a speaker received between the front cover and the rear cover, the speaker having a sound output side facing the sound emission holes, sound produced by the speaker transmitting through the sound emission holes in a direction substantially perpendicular to the display panel, and spreading to an outside environment through the recess.

14. The portable electronic device of claim 13, wherein the rear cover comprises a rear face adjacent to the recess, the rear face being substantially parallel to an inner face of the recess through which the sound emission holes extend.

15. The portable electronic device of claim 14, wherein the inner face of the recess is located nearer the front cover than the rear face of the rear cover.

16. The portable electronic device of claim 14, wherein the rear face of the rear cover is flat.

17. The portable electronic device of claim 13, wherein the sound emission holes are arranged in matrix.

18. The portable electronic device of claim 14, wherein the rear cover further comprises a reflection plate partially surrounding the sound emission holes.

19. The portable electronic device of claim 18, wherein the reflection plate is curved.

20. The portable electronic device of claim 18, wherein the reflection plate extends from the inner face of the recess along the direction substantially perpendicular to the display panel.
